(19) United States
(12) Patent Application Publication
(10) Pub. No.: US 2011/0040682 A1
(43) Pub. Date: Feb. 17, 2011

(54) AUTOMATED FUNDING FOR PREPAID CARD

(76) Inventor: Brett Vasten, Highlands Ranch, CO (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/708,668

(22) Filed: Feb. 19, 2010

Related U.S. Application Data
(60) Provisional application No. 61/234,393, filed on Aug. 17, 2009.

(51) Int. Cl. G06Q 20/00; G06Q 40/00; G06Q 10/00

(52) U.S. Cl. 705/41; 235/379; 705/44

(57) ABSTRACT

Systems and methods for funding prepaid cards or prepaid accounts in a prepaid account payroll program are presented. In one embodiment, a payroll program having employers who pay into employees' prepaid card accounts is presented. An additional prepaid account is provided for the employer, and the employer transfers funds into the additional prepaid account before the funds are disbursed from the additional prepaid account into the employees' prepaid card accounts. This transfer can be accomplished entirely within a network of a payment processing company so as to avoid interchange and merchant fees charged by banks.

### CROSS-REFERENCES TO RELATED APPLICATIONS

This application is claims the benefit of U.S. Provisional Patent Application No. 61/234,393, filed Aug. 17, 2009; the entire disclosure of which is incorporated herein by reference.

### BACKGROUND

1. Field of the Invention

Systems and methods for funding prepaid card accounts in a prepaid card account payroll program for employees are disclosed. Specifically, setting up an additional prepaid account for the employer and then using the additional prepaid account as an escrow account that, in turn, funds the employees' prepaid cards is disclosed.

2. Discussion of the Related Art

A popular form of a consumer payment device is a “prepaid card” or similar device that is “loaded” with a predetermined amount of money or linked to an account with a predetermined amount of money. The money may be used to provide payment for goods or services by presenting the card or payment device to a merchant. Prepaid cards typically look like commonly used debit or credit cards (e.g. ubiquitous plastic cards that comply with International Organization for Standards (ISO) specification document ISO 7810, ID-1 size (CR80), typically 3.370″×2.125″×0.030″).

Each prepaid card acts like a debit card in that it is tied to an account with a specified amount of money and can be used for any purchase for which a debit card may be used. A user of the prepaid card typically cannot spend more than the amount in the associated prepaid account or else a transaction attempting to do so will be halted before the sale.

A typical form of prepaid card is a payroll card issued by an employer to an employee. In some cases, the employee may not have access to other banking services. Even if the employee does have access to banking services, the employee may not take advantage of direct deposit. A prepaid account linked to a card provides a convenient way for an employer to provide salary or benefits payments to an employee. In the case of such a payroll card, the card is typically loaded by the employer with funds based on the employer's obligation to pay the employee's paycheck and/or benefits. The payroll card functions in a similar manner to a debit card in that facilitates access to an account containing an amount of money owned by the accountholder.

The use of prepaid cards for paying salaries and wages, as opposed to issuing checks or performing direct deposits to employees' bank accounts, has become prevalent in some industries in which employees do not have bank accounts of their own. The prepaid cards allow employers to pay employees while saving on printing and processing costs of physical checks. The prepaid cards also allow employers to pay their employees in a safe and convenient way.

Many employers have outsourced to outside businesses the accounting of payments of their employee salaries and wages, along with fulfilling the complex tax withholding requirements of federal, state, and local governments. These external business are sometimes called “payroll services companies.” Payroll services companies contract with card service companies, such as Visa, to provide prepaid cards.

FIG. 1 illustrates contractual relationships 100 from the perspective of a card service company, as is common in the prior art. Card service company 102 contracts with payroll services company 104, which is card service company 102's client. Payroll services company 104 contracts with employers 106 and 108 to provide payroll services, such as issuing paychecks (or paystubs for direct deposit) and W-2 tax forms. To the card service company, employers 106 and 108 are clients of their client, or “subclients.” The employers, of course, contract with employees 114, 116, and 118 for work in exchange for salaries, wages, or other compensation. The payroll services company's agreement with the card service company has the card service company providing prepaid cards to the employers' employees.

To the card service company and payroll services company, some employers are treated simply as a single, monolithic entity having one or more employees. This is common for small businesses. In the figure, Employer A 106 is shown as a monolithic employer having just two employees 114.

Other employers have a more complex structure. Large employers, such as those having multiple storefronts, outlets, warehouses, or other locations, often have employees at its different locations. For example, The Home Depot® chain of retail home improvement stores operates hardware stores and lumberyards located in many areas throughout the United States, and each store has dozens, if not hundreds, of employees at each location.

Each location of a large employer may be located in a different jurisdiction, control its own bank account for paying employees, and retain its own options for medical, dental, insurance, 401(k) plan, charitable donation, and other expenses.

Because they are located in different jurisdictions, items such as payroll taxes, insurance premiums, and donations are handled and calculated differently in the different locations.

To the card service company and payroll services company, such large employers are treated as multiple entities. In the figure, Employer B 108 is such an employer and is shown as having two locations, Location 1 (110) and Location 2 (112). Each location has several employees 116 and 118, respectively.

FIG. 2 shows prior art payroll program 200, managed by a payroll services company or card service company 220, in which employees' salaries and wages are paid using prepaid cards. Employer A 106 has two employees who are paid via prepaid cards. Each employee 114 of Employer A 106 has his or her own prepaid card 222 associated with an account. Employer B 108 has many employees under both Locations 1 (110) and 2 (112), each having his or her own prepaid card associated with an account.

When a pay period ends and it is time to pay salaries and wages, each of the accounts associated with employees' prepaid cards are funded so that the employees can use the cards like debit cards anywhere that takes the branded cards.

### BRIEF SUMMARY

Embodiments of the present application relate to systems and methods for providing prepaid accounts to the employers, which, in turn, are used to fund the employees' prepaid cards. In some embodiments, the prepaid accounts to the employers are provided through a generic employer construct that treats the employers' prepaid accounts as if they were employees' prepaid card accounts. The prepaid accounts may or may not be associated with a physical payment device (e.g. a plastic card).

One embodiment of the invention is directed to a method of funding prepaid card accounts in a prepaid card account program. The method includes receiving funds from an employer into a first prepaid account, the first prepaid account being one of a plurality of prepaid accounts, the other prepaid accounts of the plurality of prepaid accounts belonging to employees of the employer, wherein the prepaid accounts are respectively associated with physical payment devices. The method further includes verifying that the funds are received into the first prepaid account and disbursing, using a processor operatively coupled to a memory, the funds from the first prepaid account into the other prepaid accounts of the employees according to payroll obligations of the employer after verifying that the funds are received into the first prepaid account.

Another embodiment of the invention is directed to a prepaid card account program having escrow accounts. The program includes prepaid accounts in which funds can be spent from the account only if there are already funds in the prepaid account. An escrow prepaid account is assigned to an employer and the other prepaid accounts are each assigned to a worker who works for the employer, respectively. The prepaid accounts are respectively associated with physical payment devices. The program further includes an account tracking system that tracks and enforces policies for the prepaid accounts, in which the account tracking system verifies when sufficient funds to pay the workers are in the first escrow prepaid account and then disburses the funds into the workers' prepaid accounts.

Another embodiment of the invention is directed to a method of funding workers' prepaid payroll cards. The method includes paying funds into a first prepaid account, the first prepaid account associated with an employer of workers, and directing, by a processor operatively coupled to a memory, the funds to be disbursed from the first prepaid account into prepaid accounts of the workers, in which the prepaid accounts of the workers are respectively associated with physical payment devices.

Other embodiments of the invention include computer readable media including code executable by a processor, which can implement the above methods. Yet other embodiments of the invention include computers or other machines executing instructions to perform the above methods.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates contractual relationships in the prior art from the perspective of a card service company.

FIG. 2 illustrates a prior art payroll program in which employees' salaries and wages are paid using prepaid cards.

FIG. 3 illustrates a payroll program in accordance with an embodiment.

FIG. 4 illustrates a prior art method of funding employees' prepaid cards.

FIG. 5 illustrates a method of funding employees' prepaid card accounts in accordance with an embodiment.

FIG. 6 illustrates an alternate view of the method of funding employees' prepaid card accounts in FIG. 5.

FIG. 7 shows a block diagram of a system in accordance with an embodiment.

FIG. 8 is a process diagram in accordance with an embodiment.

FIG. 9 is a process diagram in accordance with an embodiment.

FIG. 10 shows a block diagram of an exemplary computer apparatus that can be used in some embodiments.

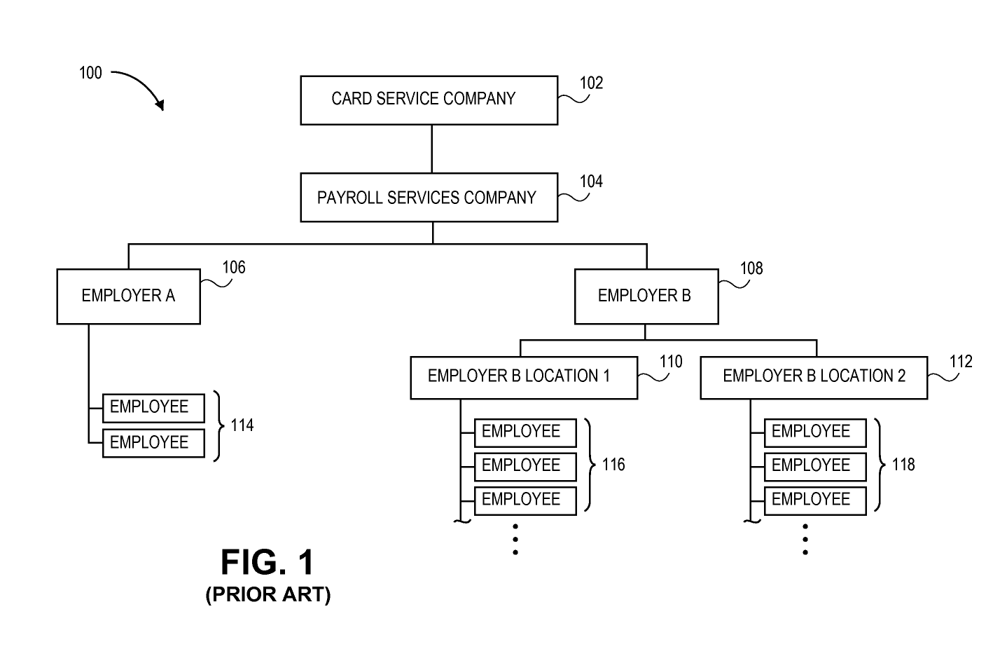

The figures will now be used to illustrate different embodiments in accordance with the invention. The figures are specific examples of embodiments and should not be interpreted as limiting embodiments, but rather exemplary forms and procedures.

### DETAILED DESCRIPTION

Payroll services companies have encountered problems in managing programs involving prepaid payroll cards. One problem has been ensuring that good funds from their clients (i.e. employers) are available before funding the employees' payroll cards. Sometimes the payroll service company will front the employees' pay but are not reimbursed because the employer shuts down or goes bankrupt before it can be reimbursed. Another problem has been in controlling the amount of money any single employer could fund at any given time. There are traditionally few controls on the amount of money that an employer can order to be paid to its employees through the payroll service company. Yet another problem was the lack of automation in the funding of the accounts used to place funds on employees' payroll cards. Many payroll transactions are performed manually. Embodiments are described herein that solve one or more of these problems.

In some embodiments, a payroll program is set up by a payroll services company and/or card service company such that employees of client employers are issued prepaid cards. The payroll program is also configured to have an additional prepaid account or prepaid accounts that are assigned to the employer.

In the payroll system, the additional prepaid account is set up as an employee's prepaid account under a generic employer. However, instead of the prepaid account being assigned to an employee, the prepaid account is assigned to the employer. The generic employer can be thought of as a ‘phantom employer’ with ‘phantom employees’ issued prepaid accounts. The phantom employees correspond to the employers enrolled in the program, and the phantom employees' prepaid accounts are essentially the employers' prepaid accounts sans the physical cards.

At the end of the payroll period, employers can transfer funds through an electronic method, e.g. ACH (Automated Clearing House), into their respective prepaid accounts. Alternatively, the employer's prepaid account can be funded by other methods, such as wire money transfers.

Funds are received into the employer's prepaid account. A prepaid account can be any type of financial account and can be managed by a bank, payroll services company, card service company (e.g. Visa), or other institution.

The prepaid account can be linked to a “physical payment device” or token. For example, suitable physical payment devices can be hand-held and compact so that they can fit into a consumer's wallet and/or pocket (e.g., pocket-sized). They may include ordinary CR80 form factor cards with or without a magnetic strip and integrated circuit memory, keychain devices (such as the Speedpass™ commercially available from Exxon-Mobil Corp.), and other convenient devices. Other examples of suitable physical payment devices include cellular phones, personal digital assistants (PDAs), pagers, security cards, access cards, smart media, dashboard transponders, and the like.

Once funds have been indicated as being received, funds are verified to be in the prepaid account. One can then verify that sufficient funds are available in the prepaid account for payment of the employees' salaries, wages, withholdings, matching contributions, etc. In this way, an employer's prepaid account can be referred to as an escrow account.

Upon verifying that sufficient funds are in the employers' escrow prepaid accounts, funds are transferred, distributed, or otherwise disbursed from the escrow prepaid accounts to the employees' prepaid card accounts.

Technical advantages over the prior art of some embodiments include that a payroll service company does not need to front the money for employers' payrolls. Instead employers fund their accounts directly from their own banks without a middleman. This also saves time in transfers and verification wait days. Also, because the payroll service company does not need to handle the funds, there is less opportunity for fraud by employees of the payroll service company, and thus less oversight of the payroll service company's employees is required. The payroll service company can concentrate on calculating withholdings, deductions, and tracking payroll funds instead of moving and securing funds. Yet another technical advantage of some embodiments is that the funds can be transferred entirely within an internal network of the payment processing company, thereby avoiding interchange fees and/or merchant fees in transferring the funds.

An “interchange fee” includes a fee that an acquirer bank (i.e. a merchant's bank) charges an issuer bank (i.e. a customer's bank) for a transaction.

A “merchant fee,” sometimes called an add-on rate or passthru fee, includes a fee that an acquirer bank charges to a merchant or other receiver of funds.

Interchange and merchant fees are often charged automatically through payment processing networks and can be substantial when large sums of money are transferred payday. Very large funds can be transferred on paydays (e.g. the end of each month) and during times when bonuses are traditionally paid (e.g. Christmas holidays).

In one embodiment in which funds are transferred from the escrow prepaid account to the prepaid card accounts of the employees, the payment is performed entirely within the internal network of the card service company. The internal network of the card service company is often the “database of record” for payments. The money transfer is not on the same network as the electronic authorization system or electronic clearing and settlement system as used by merchants and issuers; thus, interchange fees, merchant fees, and other fees are avoided in the transfer.

An employer-employee relationship is not necessary for a payroll prepaid card program. For example, an employer can pay independent contractors or other workers through prepaid accounts.

An employer can also pay providers of goods, vendors, and other suppliers. For example, the employer can use the prepaid accounts to pay for raw materials, subcomponents of deliverables, office supplies, and cleaning services.

In some embodiments, a prepaid account program has a plurality of payees each having a prepaid account. An employer payer, who is obligated to pay money to the payees, has an escrow prepaid account. The escrow prepaid account is configured to fund the payee prepaid account only. This limitation can be enabled through the same software configurations that can limit the total amount of money that can be put on a card, the amount that can be spent in any single transaction, and/or the merchant category codes (MCCs) that are authorized for payment. Software configuration changes can also limit the payees' prepaid card accounts so that the only method to add value to the payees' prepaid accounts is by funding from the escrow prepaid accounts.

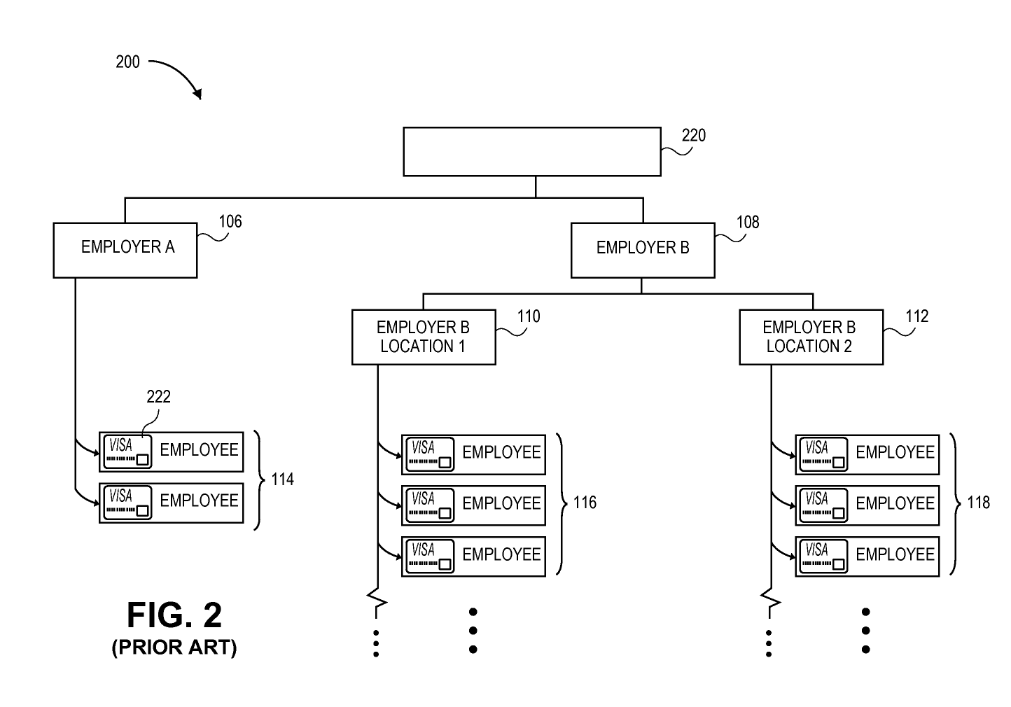

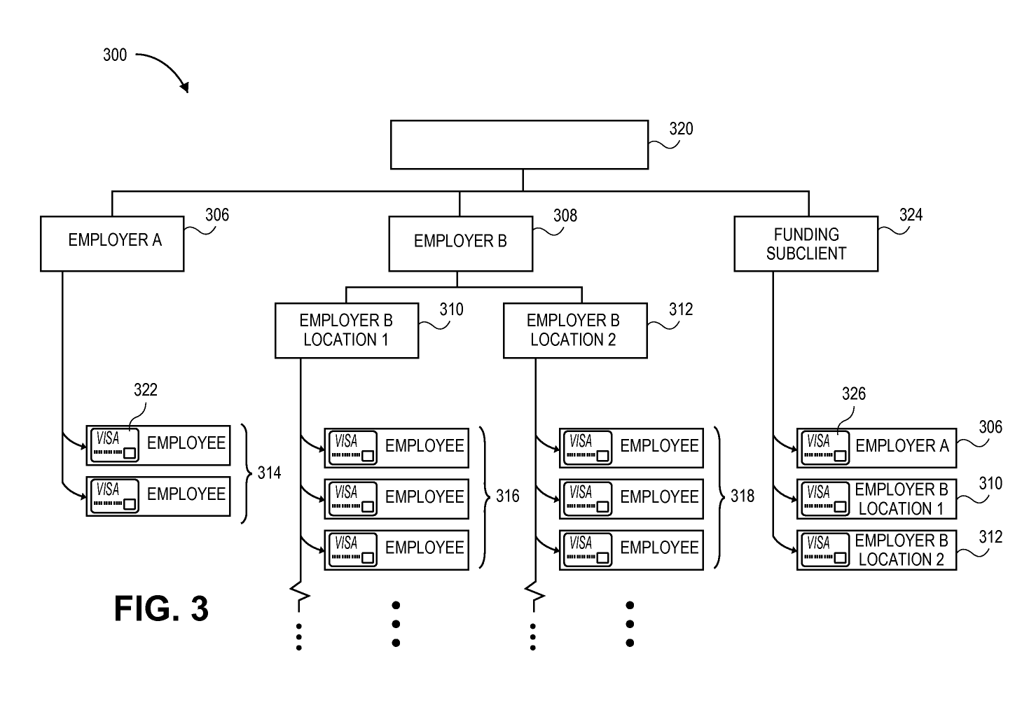

FIG. 3 illustrates payroll program 300 for employers in which each employee of employees 314, 316, and 318 has a prepaid card account. FIG. 3 is similar to FIG. 2 except for that an additional ‘funding subclient’ 324 has been added to the tree structure. The funding subclient has employee nodes below it, which are actually the other employers 306 and employer locations 316 and 318 in the tree. Because there are three other employers/employer locations in the tree, there are three employee nodes with prepaid cards under the funding subclient. In this embodiment, the number of employee nodes equals the number of other employers/employer locations in the tree.

Employer A 306 has prepaid card account 326 that can be used to pay employee prepaid card accounts 322.

An employer or employer location can have more than one funding subclient account. For example, an employer can have one prepaid account for paying employees and another prepaid account for paying independent contractors. As another example, one prepaid account can be used for paying salaried workers and another for paying hourly workers. Other variations on the number of prepaid accounts an employer owns and what workers are paid from which card are envisioned.

Payroll program 300 is configured so that the employer prepaid accounts are funded with sufficient funds before employee prepaid cards can be funded. After verification of the amounts in the employer prepaid accounts, funds (i.e. money) from the employer prepaid accounts is transferred into the employee cards.

“Sufficient funds” include an amount of funds equal to or above the sum of the payroll obligations of the employer for the set of workers that the employer wishes to pay through the prepaid account program. For example, if the sum of all employees' pay is $1M, then sufficient funds would be $1M.

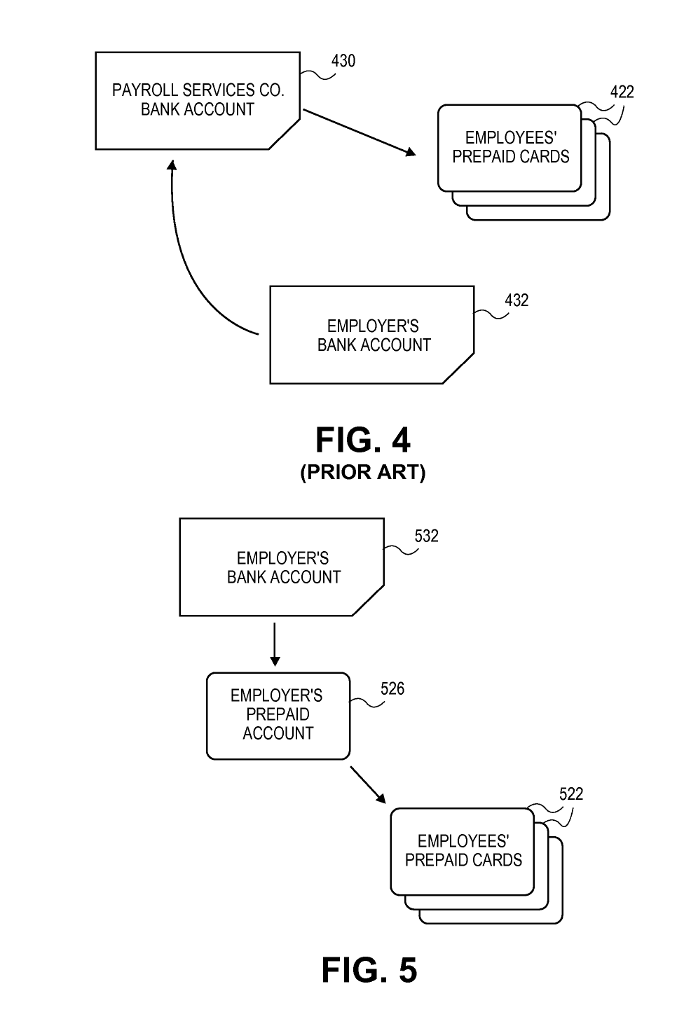

FIG. 4 illustrates a prior art payroll program with employee prepaid cards for comparison with embodiments. After an employer instructs its payroll services company to pay its employees, the payroll services company directs its bank to transfer money from its own bank account 430 directly into employees' prepaid cards 422. Because this money comes from the payroll services company bank account and not the employer's bank account, this money is essentially borrowed on credit by the employer.

To account for this under generally accepted accounting principles (GAAP), the payroll services company posts a debit to accounts receivable (and a credit to cash) to record that the employer owes the payroll services company money. Meanwhile, employer posts a credit to accounts payable (and a debit to salary/wage expense) to record that it owes money to the payroll services company.

The employer pays the debt back to the payroll services company by instructing its bank, through check or otherwise, to pay money from employer's bank account 432 to payroll services company bank account 430. The payroll services company then posts and a credit to accounts receivable to zero out accounts receivable (and a debit for the cash received). The employer posts a debit to accounts payable to zero out accounts payable (and a credit to cash).

A problem with this prior art method is that the payroll services company lends money to the employer. The lending occurs between the moment that the payroll service company pays the employees' prepaid cards and the moment that it receives money from the employer reimbursing it for the expenditure. This lending results in risk to the payroll services company. The employer can go bankrupt, go out of business, refuse to pay or delay paying back the lent amount, etc. The lending also is an opportunity cost to the payroll services company. The lent money is commonly lent without interest; thus, the payroll services company loses out on interest that could be earned.

The problems of risk and opportunity cost are compounded if there are many employers who pay on the same periodic schedule (e.g. the last day of the month). At each pay period ending date in the prior art, payroll services companies typically pay out millions of dollars all at once. This money may not be reimbursed until the employers pay them back. The can result in cash flow problems for the payroll services companies.

FIG. 5 illustrates a how a payroll program with employee prepaid card accounts works in accordance with an embodiment. First, an employer orders its bank to transfer money from its bank account 532 into its prepaid account 526 under the program. The employer then directs the payroll services company to disburse money to the employees' prepaid cards 522 from prepaid account 526. The payroll services company checks the employer's escrow prepaid card to verify that enough money has been put into the escrow prepaid card to cover payroll. If there is not enough money, then payment to employees' prepaid cards 522 is not authorized. Partial payments may be made if there are some funds available. If there is sufficient money in the escrow prepaid account, then the payroll services company transfers money from escrow prepaid account 526 to employees' prepaid cards 522.

Limits can be placed upon the employees cards so that they may only be funded by the employer's escrow account. These limits can be enforced through program software and other controls so that they cannot be circumvented. However, in some embodiments it may be prudent to allow funding sources other than the employer's prepaid account to re-charge the employees' prepaid card accounts. For example, an employee may input money from a side job into his prepaid card account so that all of his earnings are in one convenient account.

In some embodiments, limits can be placed on the employer's escrow prepaid account such that money can only be transferred, distributed, or otherwise disbursed from the account to fund employees' prepaid card accounts. In this respect, the money for payroll is better secured against fraud and theft. For example, an employer could have $100,000 in the escrow prepaid account to pay its employees and independent contractors, and it may be tempting for an insider with knowledge of the account to siphon off the top or otherwise abscond with the payroll money. However, because the funds can only be transferred from the escrow prepaid account into employees' prepaid card accounts, the insider could not asport the money by transferring the money into an off-shore or other account.

Limits on funding and spending are sometimes readily available in prepaid card account programs. Some prepaid card account programs can prevent spending at certain merchant category codes (MCCs), such as those for liquor stores. Other prepaid card account programs can limit acceptance of funds by certain prepaid cards from certain accounts, such as those owned by a parent of a child. Embodiments can use these customizable limits, already available in prepaid card account program management software, to implement the limitations discussed above.

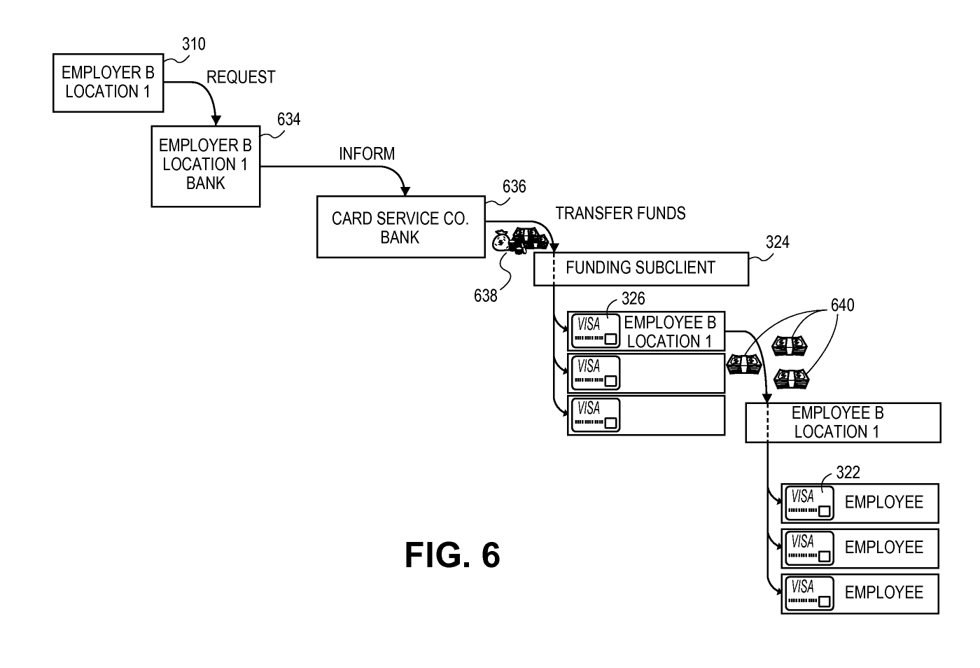

FIG. 6 illustrates an alternate view of the method of funding employees' prepaid card accounts in FIG. 5. A manager at Location 1 (310) of Employer B sends a request to Employer B Location 1's bank 634 to pay all its employees. Bank 634 informs card service company bank 636 of the transaction and transfers funds 638 through funding subclient 324 into Employer B Location 1's prepaid account 326. After the amount of the funds is verified to be safely in prepaid account 326, the funds are distributed and disbursed into smaller sums 640 through Employer B Location 1 into various employees prepaid card accounts 322.

For example, an employer may owe its three employees wages of $812.50, $812.50, and $1,052.00, respectively, at the end of a bi-monthly payroll period. The employer orders its bank to pay the sum of its payroll obligations, $2,677.00, from its bank account to the card service company bank (via ACH) for its funding subclient prepaid account. Once the card service company verifies that the $2,677.00 is in the employer's prepaid account, the amount is disbursed as follows: $812.50 into the first employee's prepaid card account, $812.50 for into the second employee's prepaid card account, and $1,052.00 into the third employee's prepaid card account.

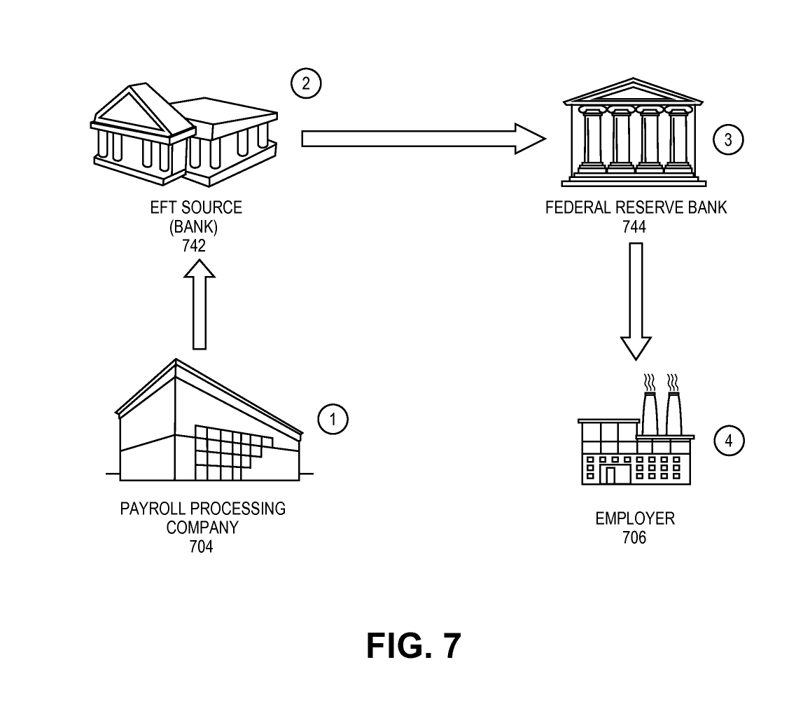

FIG. 7 shows a block diagram of one embodiment in which funds are transferred through ACH.

First, payroll processing company 704 creates a cardholder prepaid card account for an employer, and the account is created in the payroll processing company funding sub-client. This card can only be used for the purpose of funding prepaid accounts.

Second, EFT source 742, a bank, fulfills the employer's prepaid card. Delivery of the card is to payroll processing company 704. Payroll processing company 704 enters the card information into the employer location as the sole funding account.

Third, the employer receives the routing and transit number (RTN/DDA) for the funding card. The employer deposits funds to the funding card through ACH.

Fourth, employer 706 funds both new enrollments and re-loads existing employees' prepaid cards using the funding account. If there are not sufficient funds to cover the load amount, the load attempt will be declined. Employer 706 can add additional funds to the employer's card using ACH.

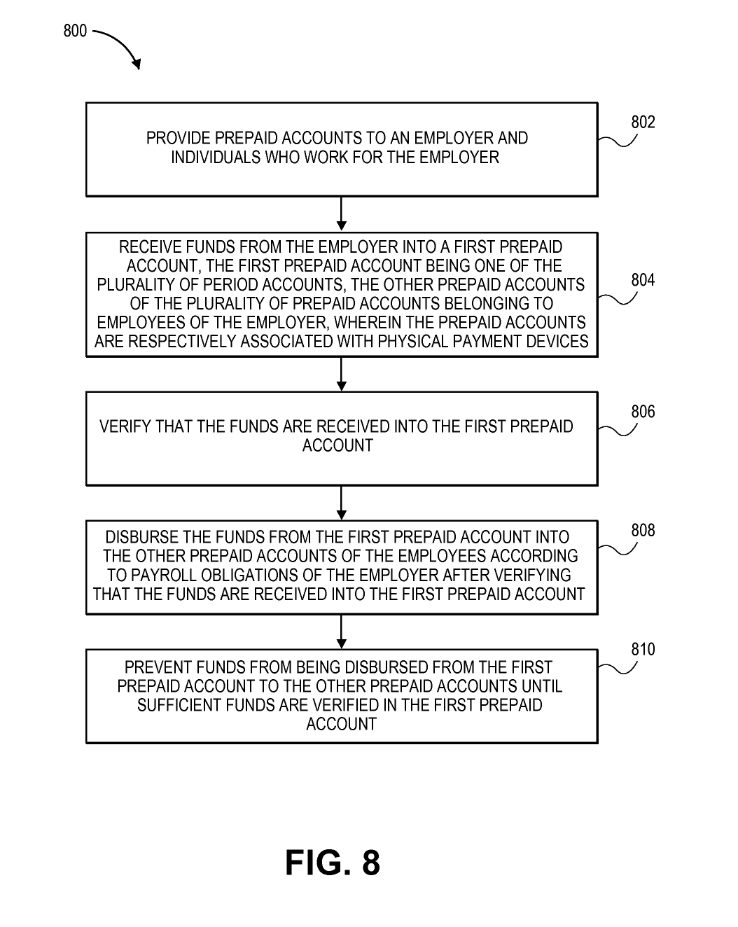

FIG. 8 is a flowchart illustrating a process in accordance with an embodiment. This process, process 800, can be automated in a computer or other machine. The process can be coded in software, firmware, or hard coded as machine-readable instructions and run through a processor that can implement the instructions. In operation 802, prepaid accounts are provided to an employer and individuals who work for the employer. In operation 804, funds are received from the employer into a first prepaid account, the first prepaid account being one of the plurality of prepaid accounts, the other prepaid accounts of the plurality of prepaid accounts belonging to employees of the employer, wherein the prepaid accounts are respectively associated with physical payment devices. In operation 806, it is verified that the funds are received into the first prepaid account. In operation 808, the funds are disbursed from the first prepaid account into the other prepaid accounts of the employees according to payroll obligations of the employer after verifying that the funds are received into the first prepaid account. In operation 810, funds are prevented from being disbursed from the first prepaid account to the other prepaid accounts until sufficient funds are verified in the first prepaid account.

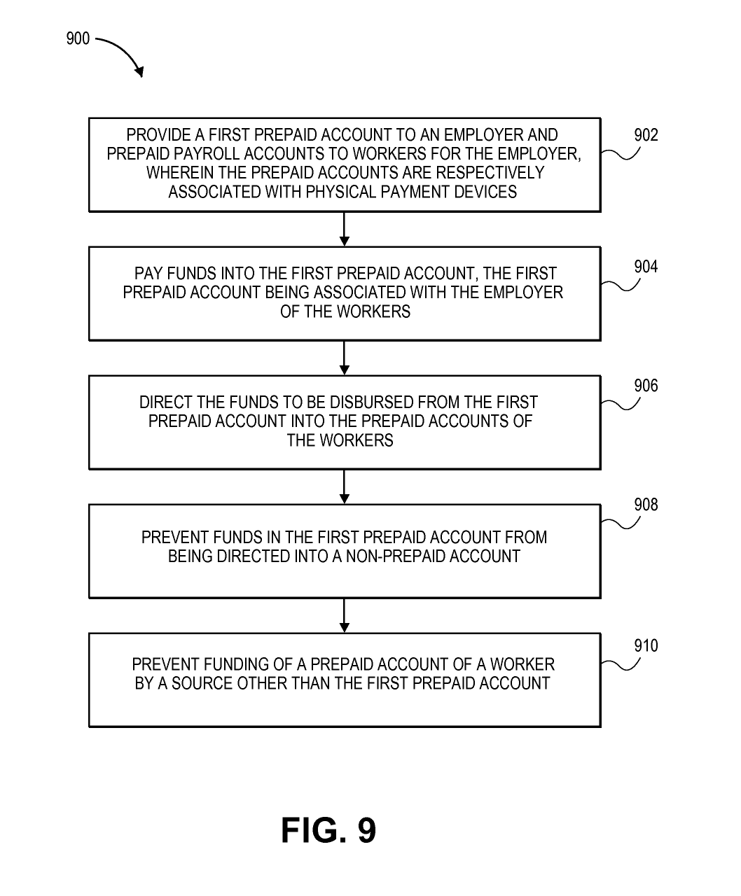

FIG. 9 is a flowchart illustrating a process in accordance with an embodiment. In operation 902, a first prepaid account is provided to an employer and prepaid payroll accounts to workers for the employer, wherein the prepaid accounts are respectively associated with physical payment devices. In operation 904, funds are paid into the first prepaid account, the first prepaid account being associated with the employer of the workers. In operation 906, the funds are directed to be disbursed from the first prepaid account into the prepaid accounts of the workers. In operation 908, funds in the first prepaid account are prevented from being directed into a non-prepaid account. In operation 910, funding of a prepaid account of a worker by a source other than the first prepaid account is prevented.

The various participants and elements in the aforementioned figures may operate one or more computer apparatuses to facilitate the functions described herein. Any of the elements in the figure may use any suitable number of subsystems to facilitate the functions described herein.

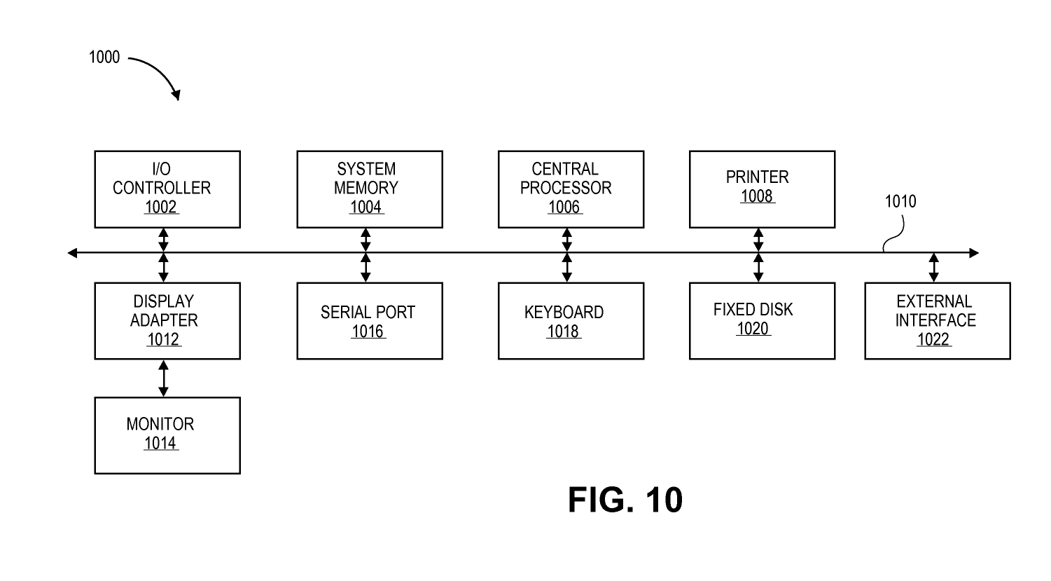

Examples of such subsystems or components are shown in FIG. 10. The subsystems shown in the figure are interconnected via a system bus 1010. Additional subsystems such as a printer 1008, keyboard 1018, fixed disk 1020 (or other memory comprising computer readable media), monitor 1014, which is coupled to display adapter 1012, and others are shown. Peripherals and input/output (I/O) devices, which couple to I/O controller 1002, can be connected to the computer system by any number of means known in the art, such as serial port 1016. For example, serial port 1016 or external interface 1022 can be used to connect the computer apparatus to a wide area network such as the Internet, a mouse input device, or a scanner. The interconnection via system bus allows the central processor 1006 to communicate with each subsystem and to control the execution of instructions from system memory 1004 or the fixed disk 1020, as well as the exchange of information between subsystems. The system memory 1004 and/or the fixed disk 1020 may embody a tangible computer readable medium.

Embodiments of the invention are not limited to the above-described embodiments. For example, although separate functional blocks are shown for an issuer, payment processing network, and acquirer, some entities perform all of these functions and may be included in embodiments of invention.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving funds from an employer into a first prepaid account, the first prepaid account being one of a plurality of prepaid accounts, the other prepaid accounts of the plurality of prepaid accounts belonging to employees of the employer, wherein the prepaid accounts are respectively associated with physical payment devices;
verifying that the funds are received into the first prepaid account; and
disbursing, using a processor operatively coupled to a memory, the funds from the first prepaid account into the other prepaid accounts of the employees according to payroll obligations of the employer after verifying that the funds are received into the first prepaid account.

2. The method of claim 1 wherein disbursing the funds from the first prepaid account into the other prepaid accounts is performed entirely within an internal network of a payment processing company, thereby avoiding interchange fees and merchant fees in transferring the funds.

3. The method of claim 1 wherein the other prepaid accounts belonging to employees are configured to accept funds from the first prepaid account only, thereby reducing ways to circumvent the verification.

4. The method of claim 1 wherein the first prepaid account is configured to only disburse funds into other prepaid accounts, thereby reducing ways a potential thief could abscond with the funds.

5. The method of claim 1 further comprising:
providing the prepaid accounts to the employer and employees.

6. The method of claim 1 wherein each of the other prepaid accounts is associated with a physical wallet card.

7. The method of claim 6 wherein the physical card is a CR80 size card.

8. The method of claim 1 wherein the operations are performed in the order as shown.

9. The method of claim 1 wherein each operation is performed by the processor operatively coupled to the memory.

10. A machine-readable storage medium embodying information indicative of instructions for causing one or more machines to perform the operations of claim 1.

11. A computer system executing instructions in a computer program, the computer program instructions comprising program code for performing the operations of claim 1.

12. A prepaid account payroll program comprising:
prepaid accounts in which funds can be spent from the accounts only if there are already funds in the prepaid account, wherein an escrow prepaid account is assigned to an employer and the other prepaid accounts are each assigned to a worker who works for the employer, the prepaid accounts being respectively associated with physical payment devices; and
an account tracking system that tracks and enforces policies for the prepaid accounts, wherein the account tracking system verifies when sufficient funds to pay the workers are in the first escrow prepaid account and then disburses the funds into the workers' prepaid accounts.

13. The program of claim 12 wherein disbursing the funds from the escrow prepaid account into the other prepaid accounts is performed entirely within an internal network of a payment processing company, thereby avoiding interchange fees and merchant fees in transferring the funds.

14. The program of claim 12 wherein the escrow prepaid account is configured to be funded from a bank of the employer.

15. The program of claim 12 wherein the workers are one of the group consisting of employees of the employer and independent contractors who work for the employer.

16. A method comprising:
paying funds into a first prepaid account, the first prepaid account associated with an employer of workers; and
directing, by a processor operatively coupled to a memory, the funds to be disbursed from the first prepaid account into prepaid accounts of the workers, wherein the prepaid accounts of the workers are respectively associated with physical payment devices.

17. The method of claim 16 wherein the disbursement is directed to be performed entirely within an internal network of a payment processing company, thereby avoiding interchange fees and merchant fees in transferring the funds.

18. The program of claim 16 wherein the workers are one of the group consisting of employees and independent contractors.

19. The method of claim 16 wherein the prepaid accounts of the workers are configured to accept funds from the first prepaid account only.

20. The method of claim 16 wherein the first prepaid account is configured to only disburse funds into the prepaid accounts of the workers.
